(19) United States
(12) Patent Application Publication
(10) Pub. No.: US 2026/0016645 A1
(43) Pub. Date: Jan. 15, 2026

(54) OPTICAL MODULE AND OPTICAL CONNECTOR CABLE

(71) Applicant: SUMITOMO ELECTRIC INDUSTRIES, LTD., Osaka (JP)

(72) Inventors: Shun ENDO, Osaka-shi (JP); Masaki SUZUKI, Osaka-shi (JP); Yasunori ASANO, Osaka-shi (JP); Takeshi INOUE, Osaka-shi (JP)

(73) Assignee: SUMITOMO ELECTRIC INDUSTRIES, LTD., Osaka (JP)

(21) Appl. No.: 19/258,331

(22) Filed: Jul. 2, 2025

(30) Foreign Application Priority Data
Jul. 11, 2024 (JP) 2024-111566

(51) Int. Cl. G02B 6/42; G02B 6/44

(52) U.S. Cl. CPC G02B 6/4214; G02B 6/4239; G02B 6/4401

(57) ABSTRACT

An optical module includes an optical device, a lens component in which an optical path between an optical fiber and the optical device is provided, and a protective member. The lens component includes an optical fiber support portion configured to hold the optical fiber, a lens portion through which the optical path between the optical fiber and the optical device passes, and a mirror portion configured to be a part of an outer surface of the lens component. The optical path is bent at the mirror portion. The protective member is attached to the outer surface of the lens component and configured to prevent the mirror portion from being exposed.

### CROSS REFERENCE TO RELATED APPLICATION

This application claims priority based on Japanese Patent Application No. 2024-111566 filed on Jul. 11, 2024, the entire contents of which are incorporated herein by reference.

### TECHNICAL FIELD

The present disclosure relates to an optical module and an optical connector cable.

### BACKGROUND

Patent literature 1 (Japanese Unexamined Patent Application Publication No. 2019-082508) discloses an optical component and an optical connector cable. The optical component includes a substrate on which an optical device is mounted, and a lens component disposed on a mounting surface of the substrate. The lens component has a first surface located on an outer side and a second surface located on an inner side opposite to the first surface and facing the mounting surface. A recessed portion is formed in the first surface, and a part of a surface of the recessed portion serves as a light reflection surface.

Patent literature 2 (International Publication WO 2023/013348) discloses an optical module and an optical connector cable. The optical module includes an optical coupling module that optically couples an optical device mounted on a substrate to an optical fiber. The optical coupling module includes a mirror that changes a propagation direction of light emitted from the optical fiber, and a lens that converges the light reflected from the mirror and causes the light to be incident on the optical device.

### SUMMARY

An optical module according to an embodiment of the present disclosure includes an optical device, a lens component in which an optical path between an optical fiber and the optical device is provided, and a protective member. The lens component includes an optical fiber support portion configured to hold the optical fiber, a lens portion through which the optical path between the optical fiber and the optical device passes, and a mirror portion configured to be a part of an outer surface of the lens component. The optical path is bent at the mirror portion. The protective member is attached to the outer surface of the lens component and configured to prevent the mirror portion from being exposed.

### BRIEF DESCRIPTION OF THE DRAWINGS

FIG. 1 is a perspective view of an optical connector cable according to an embodiment of the present disclosure.

FIG. 2 is a perspective view of the optical connector cable before an optical fiber cable is attached to an optical module.

FIG. 3 is a cross-sectional view taken along the line III-III of FIG. 1.

FIG. 4 is a cross-sectional view which is taken along a line similar to the line III-III and illustrates a configuration of an optical module according to a first modification.

FIG. 5 is a cross-sectional view which is taken along a line similar to the line III-III and illustrates a configuration of an optical module according to a second modification.

FIG. 6 is a cross-sectional view which is taken along a line similar to the line III-III and illustrates a configuration of an optical module according to a third modification.

### DETAILED DESCRIPTION

In order to couple an optical device disposed on a substrate to an optical fiber, for example, the lens component disclosed in Patent literature 1 is used. The lens component has a recessed portion formed in an outer surface opposite to the substrate. A part of the surface of the recessed portion functions as a mirror portion (light reflection surface) that reflects light propagating inside the lens component. In such a configuration, when dust enters the recessed portion and adheres to the mirror portion, the light reflectance of the mirror portion is reduced, and as a result, the optical coupling efficiency between the optical device and the optical fiber is reduced. In particular, when the lens component is not covered by a housing or the like, dust from the surrounding area can be easily adhered to the mirror portion.

The present disclosure provides an optical module and an optical connector cable that can reduce adhesion of dust to a mirror portion.

### DESCRIPTION OF EMBODIMENTS OF PRESENT DISCLOSURE

First, the contents of embodiments of the present disclosure will be listed and described.

[1] An optical module according to an embodiment of the present disclosure includes an optical device, a lens component in which an optical path between an optical fiber and the optical device is provided, and a protective member. The lens component includes an optical fiber support portion configured to hold the optical fiber, a lens portion through which the optical path between the optical fiber and the optical device passes, and a mirror portion configured to be a part of an outer surface of the lens component. The optical path is bent at the mirror portion. The protective member is attached to the outer surface of the lens component and configured to prevent the mirror portion from being exposed.

In the optical module according to the above [1], the protective member is attached to the outer surface of the lens component to prevent the mirror portion from being exposed. This makes it possible to reduce adhesion of dust to the mirror portion. Thus, it is possible to suppress a decrease in the light reflectance of the mirror portion, and to suppress a decrease in the optical coupling efficiency between the optical device and the optical fiber.

[2] In the optical module according to the above [1], the outer surface of the lens component may include a recessed portion, the mirror portion may be configured to be a part of a surface of the recessed portion, and the protective member may cover an opening of the recessed portion. In this case, the mirror portion is protected in a space surrounded by the recessed portion and the protective member. Thus, it is possible to reduce dust entering the recessed portion and to reduce adhesion of dust to the mirror portion.

[3] In the optical module according to the above [2], the protective member may be an adhesive film adhered to the outer surface. In this case, the opening of the recessed portion can be covered by a simple structure.

[4] In the optical module according to the above [2], the protective member may be a resin fixed to the outer surface. In this case, the opening of the recessed portion can be covered by a simple structure.

[5] In the optical module according to the above [1], the protective member may be in contact with the outer surface around the mirror portion, and a space between the protective member and the mirror portion may be provided. In this case, it is possible to reduce adhesion of dust to the mirror portion and to suppress a decrease in the light reflectance of the mirror portion due to disposing the protective member.

[6] In the optical module according to the above [1], the protective member may include a fiber body that covers the mirror portion or a porous body that covers the mirror portion. In this case, the protective member can be a simple structure.

[7] An optical connector cable according to an embodiment of the present disclosure includes the optical module according to any one of the above [1] to [6] and an optical fiber cable including the optical fiber tip end portion of which is held by the optical module. According to the optical connector cable, it is possible to reduce adhesion of dust to the mirror portion. Thus, it is possible to suppress a decrease in the light reflectance of the mirror portion, and to suppress a decrease in the optical coupling efficiency between the optical device and the optical fiber.

### DETAILS OF EMBODIMENTS OF PRESENT DISCLOSURE

Specific examples of the present disclosure will be described below with reference to the drawings. The present invention is not limited to the examples, but is defined by the scope of the claims and is intended to include all modifications within the meaning and scope equivalent to the scope of the claims. In the following description, the same elements are denoted by the same reference numerals in the description of the drawings, and redundant description thereof will be omitted.

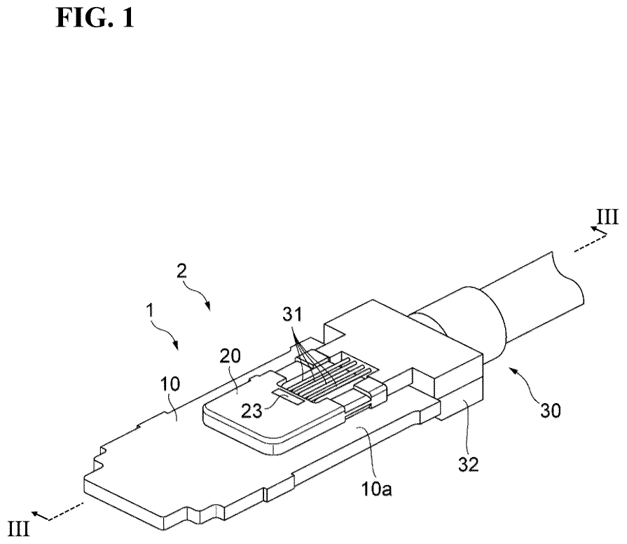

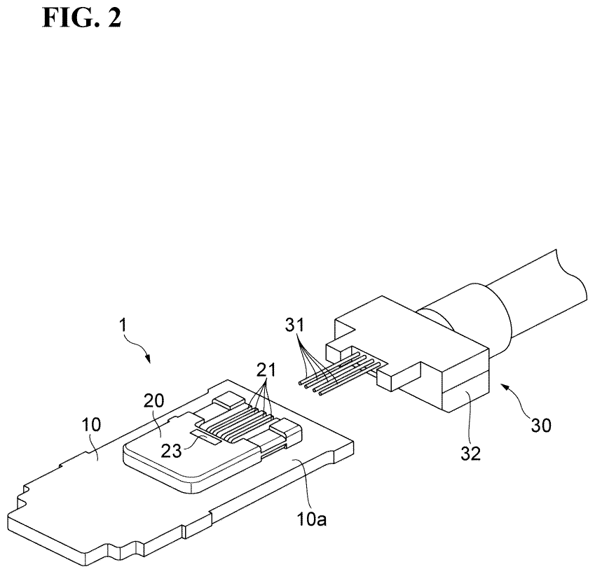

FIG. 1 is a perspective view of an optical connector cable 2 according to an embodiment of the present disclosure. FIG. 2 is a perspective view of the optical connector cable 2 before an optical fiber cable 30 is attached to an optical module 1. As illustrated in FIG. 1 and FIG. 2, the optical connector cable 2 includes the optical module 1 and the optical fiber cable 30. The optical module 1 includes a circuit board 10 and a lens component 20. The lens component 20 is disposed on a flat main surface 10a (mounting surface) of the circuit board 10 and is fixed to the main surface 10a.

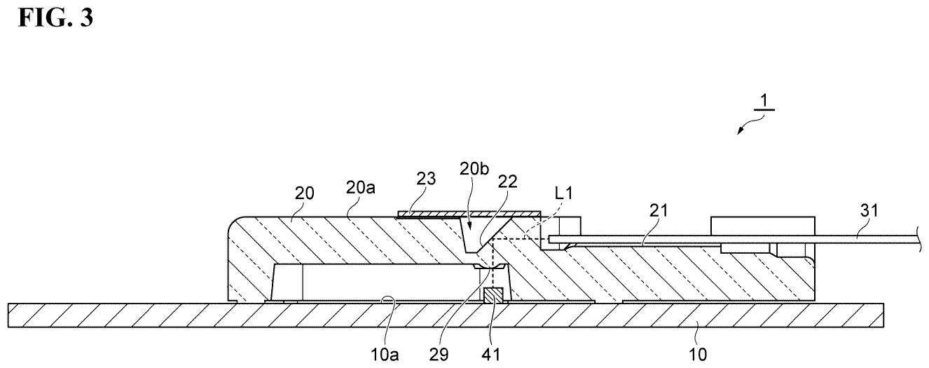

FIG. 3 is a cross-sectional view of the optical module 1. As illustrated in FIG. 3, the optical module 1 further includes an optical device 41. The optical device 41 is mounted on the main surface 10a of the circuit board 10 and is located between the circuit board 10 and the lens component 20. The lens component 20 is disposed so as to cover the optical device 41. The optical device 41 includes a photoelectric conversion device which is a light receiving device such as a photodiode (PD) and a light emitting device such as a vertical cavity surface emitting laser (VCSEL), and has an optical axis along a direction intersecting the main surface 10a (for example, a normal direction of the main surface 10a).

Reference is again made to FIG. 1 and FIG. 2. The optical fiber cable 30 includes a plurality of optical fibers 31 and a support member 32. Most of optical fibers 31 are housed inside a coating, and a tip end portion of each of optical fibers 31 is exposed to the outside from the coating. Each of optical fibers 31 is optically coupled to the optical device 41 with the lens component 20. The support member 32 defines fiber pitches and extending directions of the tip end portions of the plurality of optical fibers 31. The support member 32 aligns the tip end portions of the plurality of optical fibers 31 so as to be parallel to each other, for example.

As illustrated in FIG. 3, the lens component 20 includes an optical path L1 between the optical fiber 31 and the optical device 41 therein. In order to propagate light inside the lens component 20, at least a portion of the lens component 20 including the optical path L1 is formed of a transparent material through which light can propagate, for example, glass, a transparent resin, or the like. The transparent resin is, for example, a polyetherimide resin. In one example, the lens component 20 is a plate-like member having a rectangular planar shape, and the entire lens component 20 is made of a light-transmissive material. In FIG. 3, the support member 32 is omitted.

The lens component 20 includes a plurality of grooves 21, a mirror portion 22, and a lens portion 29. The plurality of grooves 21 are formed in a region of an outer surface 20a of the lens component 20. The region in which the grooves 21 are formed is closer to the optical fiber cable 30. Each of the tip end portions of the aligned optical fibers 31 is placed in respective one of the grooves 21 and fixed to respective one of the grooves 21 with an adhesive (not shown). The plurality of grooves 21 are optical fiber support portions that hold the plurality of optical fibers 31.

The mirror portion 22 is optically coupled to the plurality of optical fibers 31. As illustrated in FIG. 3, the mirror portion 22 changes a propagation direction of light to form the bent optical path L1 between the optical fiber 31 and the optical device 41. The mirror portion 22 changes the propagation direction of light propagating from each of the optical fibers 31 in a horizontal direction (in a direction along the main surface 10a of the circuit board 10) to a vertical direction (a direction intersecting the main surface 10a). Alternatively, the mirror portion 22 changes the propagation direction of the light propagating in the vertical direction from the optical device 41 to the horizontal direction.

The mirror portion 22 forms a part of the outer surface 20a of the lens component 20. In the present embodiment, the lens component 20 incudes a recessed portion 20b formed on the outer surface 20a, and the mirror portion 22 forms a part of a surface of the recessed portion 20b. The recessed portion 20b is recessed toward the circuit board 10 on the outer surface 20a. A face closer to the optical fiber 31 of a plurality of faces forming the surface of the recessed portion 20b is inclined with respect to the optical path L1. The mirror portion 22 is formed of the inclined face. The face (a part of the surface of the recessed portion 20b) forming the mirror portion 22 reflects light due to a difference in refractive index between a material forming the lens component 20 and air present in the recessed portion 20b.

The optical path between the optical fiber 31 and the optical device 41 passes through the lens portion 29. In one example, as illustrated in FIG. 3, the lens portion 29 is formed in a convex shape at a surface of the lens component 20 facing the circuit board 10. In this case, the optical path L1 between the optical device 41 and the mirror portion 22 passes through the lens portion 29. The mirror portion 22 is optically coupled to the optical device 41 via the lens portion 29.

A protective member 23 is attached to the outer surface 20a of the lens component 20 and is configured to prevent the mirror portion 22 from being exposed without contacting the mirror portion 22. The protective member 23 of the present embodiment is an adhesive film adhered to the outer surface 20a and adhered to the peripheral portion of an opening of the recessed portion 20b to cover the opening of the recessed portion 20b. The adhesive film is formed of a resin film with an adhesive applied on one side. A space for holding air in contact with the mirror portion 22 is formed by the recessed portion 20b and the protective member 23. The opening of the recessed portion 20b may be hermetically sealed by the protective member 23. The material of the film is, for example, polyimide, cellophane, polyester, polypropylene, or polyolefin.

The effects achieved by the optical module 1 and the optical connector cable 2 according to the present embodiment described above will be described. In a conventional optical module without the protective member 23, when dust enters and adheres to the mirror portion 22, the light reflectance of the mirror portion 22 decreases, and as a result, the optical coupling efficiency between the optical device 41 and the optical fiber 31 decreases. In particular, when the optical module is not covered by a housing or the like, dust from the surrounding area can easily adhere to the mirror portion 22. In a general-purpose electronic apparatus such as a personal computer, a housing or the like covering an optical module may be omitted for the purpose of size and weight reduction. In such an electronic device, a vent hole may be provided to release heat generated inside. For example, in such a case, the above-described problem easily occurs due to dust entering from the vent hole.

In the present embodiment, the protective member 23 is attached to the outer surface 20a of the lens component 20 to prevent the mirror portion 22 from being exposed. This makes it possible to reduce adhesion of dust to the mirror portion 22. Thus, it is possible to suppress a decrease in the light reflectance of the mirror portion 22, and to suppress a decrease in the optical coupling efficiency between the optical device 41 and the optical fiber 31.

As in the present embodiment, the outer surface 20a may include the recessed portion 20b, the mirror portion 22 may form a part of the surface of the recessed portion 20b, and the protective member 23 may cover the opening of the recessed portion 20b. In this case, the mirror portion 22 is protected in a space surrounded by the recessed portion 20b and the protective member 23. Thus, it is possible to reduce dust entering the recessed portion 20b and to reduce adhesion of dust to the mirror portion 22.

As in the present embodiment, the protective member 23 may be an adhesive film adhered to the outer surface 20a. In this case, the opening of the recessed portion 20b can be covered by a simple structure.

### First Modification

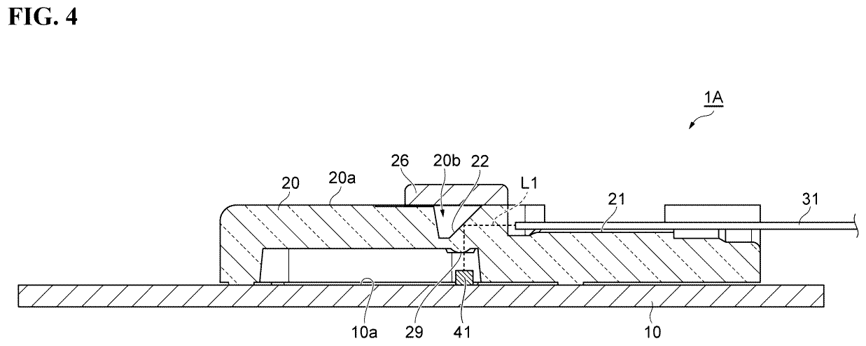

FIG. 4 is a cross-sectional view illustrating a configuration of an optical module 1A according to a first modification of the present disclosure. The optical connector cable 2 may include the optical module 1A of the present modification instead of the optical module 1 of the above embodiment. As illustrated in FIG. 4, the optical module 1A of the present modification includes a protective member 26 instead of the protective member 23 of the above embodiment.

The protective member 26 is attached to the outer surface 20a of the lens component 20 and is configured to prevent the mirror portion 22 from being exposed without contacting the mirror portion 22. The protective member 26 of the present modification is a resin fixed to the outer surface 20a, and is fixed to the peripheral portion of the opening of the recessed portion 20b to cover the opening of the recessed portion 20b. Thus, a space for holding air in contact with the mirror portion 22 is formed by the recessed portion 20b and the protective member 26. The opening of the recessed portion 20b may be hermetically sealed by the protective member 26. Examples of the resin used for the protective member 26 include acrylic resin and epoxy resin. The resin preferably has a high viscosity before curing in order to prevent contact with the mirror portion 22. In one example, the material of the protective member 26 is a resin putty.

As in the present modification, the protective member 26 may be a resin fixed to the outer surface 20a. In this case, the same effects as those of the above embodiment can be achieved, and the opening of the recessed portion 20b can be covered by a simple structure.

### Second Modification

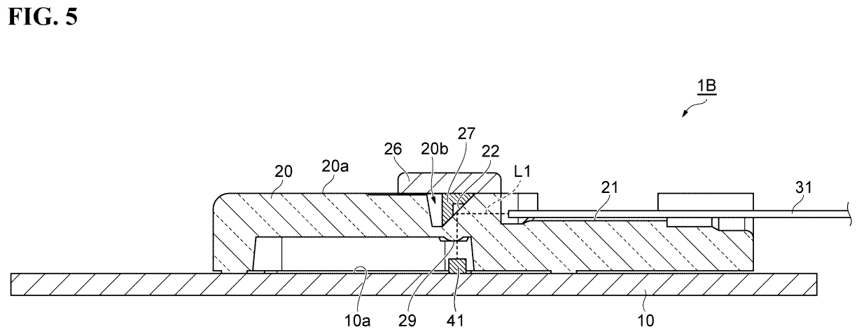

FIG. 5 is a cross-sectional view illustrating a configuration of an optical module 1B according to a second modification of the present disclosure. The optical connector cable 2 may include the optical module 1B of the present modification instead of the optical module 1 of the above embodiment. As illustrated in FIG. 5, the optical module 1B of the present modification includes the protective member 26 and a protective member 27 instead of the protective member 23 of the above embodiment.

The protective member 27 is in contact with the outer surface 20a around the mirror portion 22, and a space between the mirror portion 22 and the protective member 27 is provided, so that the protective member 27 does not come into contact with the mirror portion 22. In the illustrated example, the protective member 27 is accommodated in the recessed portion 20b and is in contact with the part of the surface of the recessed portion 20b around the mirror portion 22. The protective member 27 may be held in the recessed portion 20b by the protective member 26 of the first modification (or by the protective member 23 of the above embodiment), or may be fixed to the lens component 20 by being adhered to the outer surface 20a (e.g., to the part of the surface of the recessed portion 20b). In the illustrated example, the protective member 27 has an L-shape in a cross section including the optical path L1, but the shape of the protective member 27 is not limited thereto. The material of the protective member 27 is, for example, resin. The material of the protective member 27 may be the same as or different from the material of the lens component 20. When the material of the protective member 27 is the same as the material of the lens component 20, the protective member 27 and the lens component 20 can be easily adhered to each other.

As in the present modification, the protective member 27 may be in contact with the outer surface 20a around the mirror portion 22, and a space between the protective member 27 and the mirror portion 22 may be provided. In this case, it is possible to reduce adhesion of dust to the mirror portion 22 and to suppress a decrease in the light reflectance of the mirror portion 22 due to providing the protective member 27. Furthermore, the protective member 27 is provided in addition to the protective member 26 (or the protective member 23), and thereby, it is possible to more effectively reduce adhesion of dust to the mirror portion 22.

### Third Modification

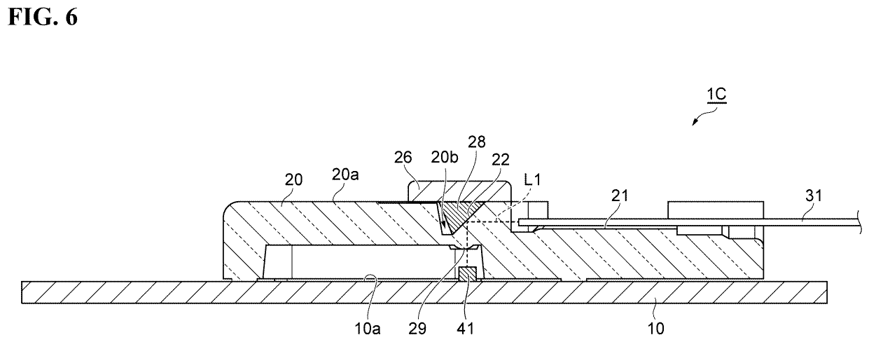

FIG. 6 is a cross-sectional view illustrating a configuration of an optical module 1C according to a third modification of the present disclosure. The optical connector cable 2 may include the optical module 1C of the present modification instead of the optical module 1 of the above embodiment. As illustrated in FIG. 6, the optical module 1C of the present modification includes the protective member 26 and a protective member 28 instead of the protective member 23 of the above embodiment.

The protective member 28 includes a fiber body or a porous body that covers the mirror portion 22. The fiber body is, for example, cotton. The porous body is, for example, a foamed resin. Unlike the above embodiment and modifications, the protective member 28 of the present modification may be in contact with the mirror portion 22. The protective member 28 is disposed to cover the mirror portion 22. In the illustrated example, the protective member 28 is accommodated in the recessed portion 20b. The protective member 28 may be held in the recessed portion 20b by the protective member 26 of the first modification (or the protective member 23 of the above embodiment), or may be fixed to the lens component 20 by being adhered to the outer surface 20a (e.g., to the part of the surface of the recessed portion 20b). In a case in which the protective member 28 is adhered to the outer surface 20a, the adhesive used is applied so as not to come into contact with the mirror portion 22.

As in the present modification, the protective member 28 may include a fiber body or a porous body that covers the mirror portion 22. The fiber body and the porous body have a slight influence on the light reflectance even when the fiber body and the porous body are in contact with the mirror portion 22. According to the present modification, the same effects as those of the above embodiment can be achieved, and the protective member 28 can be formed in a simple structure. In addition, in many cases, the fiber body and the porous body are lightweight, and thus can contribute to a reduction in weight of the optical module 1C. In addition, in many cases, the fiber body and the porous body have flexibility, and thus it is possible to reduce the risk of damaging the mirror portion 22 during the assembly work of the optical module 1C.

The optical module and the optical connector cable according to the present disclosure are not limited to the above-described embodiments, and various modifications can be made. For example, in the above embodiment and modifications, the lens component 20 includes the recessed portion 20b, and the mirror portion 22 is formed as a part of the surface of the recessed portion 20b. The mirror portion 22 is not limited to this configuration, and may be a part of the outer surface 20a of the lens component 20 that is not the recessed portion. In such a case, the same effects as those of the above-described embodiment can be achieved by attaching the protective member to the outer surface 20a of the lens component 20 and configuring the protective member to prevent the mirror portion 22 from being exposed.

What is claimed is:

1. An optical module comprising:
an optical device;
a lens component in which an optical path between an optical fiber and the optical device is provided; and
a protective member,
wherein the lens component includes
an optical fiber support portion configured to hold the optical fiber,
a lens portion through which the optical path between the optical fiber and the optical device passes, and
a mirror portion configured to be a part of an outer surface of the lens component,
wherein the optical path is bent at the mirror portion, and
wherein the protective member is attached to the outer surface of the lens component and configured to prevent the mirror portion from being exposed.

2. The optical module according to claim 1,
wherein the outer surface of the lens component includes a recessed portion,
wherein the mirror portion is configured to be a part of a surface of the recessed portion, and
wherein the protective member covers an opening of the recessed portion.

3. The optical module according to claim 2, wherein the protective member is an adhesive film adhered to the outer surface.

4. The optical module according to claim 2, wherein the protective member is a resin fixed to the outer surface.

5. The optical module according to claim 1,
wherein the protective member is in contact with the outer surface around the mirror portion, and
wherein a space between the protective member and the mirror portion is provided.

6. The optical module according to claim 1, wherein the protective member includes a fiber body that covers the mirror portion or a porous body that covers the mirror portion.

7. An optical connector cable comprising:
the optical module according to claim 1; and
an optical fiber cable including the optical fiber tip end portion of which is held by the optical module.
